(19) United States
(12) Patent Application Publication
(10) Pub. No.: US 2016/0326791 A1
(43) Pub. Date: Nov. 10, 2016

(54) Folding-Shutter Assembly

(71) Applicant: BELU VERWALTUNGSGESELLSCHAFT MBH, Lingen/Ems (DE)

(72) Inventor: Bernhard Lucas, Lingen/Ems (DE)

(21) Appl. No.: 15/109,871

(22) PCT Filed: Jan. 12, 2015
(86) PCT No.: PCT/EP2015/000032

§ 371 Date: Jul. 6, 2016

(30) Foreign Application Priority Data
Jan. 10, 2014 (DE) 20 2014 000 071.9

(51) Int. Cl. E05F 15/665; E05F 15/605; E06B 3/48

(52) U.S. Cl. CPC E05F 15/665; E06B 3/483; E05F 15/605; E05Y 2900/132; E05Y 2900/146

(57) ABSTRACT

The invention relates to a folding-shutter assembly comprising: two or more folding shutters that can be moved on at least one guide; at least one drive associated with the guides for opening or closing the folding-shutter assembly; at least one raising and lowering means actuated by the drive; at least one adjusting means actuated by the drive; and at least one coupling means coupling means couples the drive to or uncouples the drive from the adjusting means in the sense of driving when the coupling means is actuated in the one or the other sense in dependence on the pivoting state of the one of the folding-shutter elements.

The present invention claims priority on PCT Application No. PCT/EP2015/000032 filed Jan. 12, 2015, wherein in turn claims priority on German Patent Application No. 20 2014 000 071.9 filed Jan. 10, 2014.

### FIELD OF THE INVENTION

The invention relates to a folding shutter arrangement according to the preamble of claim 1. According thereto, a folding shutter arrangement is provided with folding shutters that are displaceable on guides, in particular liftable in the opening direction and lowerable in the closing direction. The folding shutter arrangement has, for the first part, element edges that do not fold up and are held and displaceable with respect to the guides. At least one pair of folding shutter edges forms, with respect to the guide rail(s), a (folding-up) joint that folds up during opening and comes away from the guides. At least one motorized or manual drive, preferably a rotary drive, (referred to below as drive) is provided on or in the vicinity of at least one of the guide rails or guide rail ends. At least one lifting and lowering means, such as a traction means for lifting and lowering the folding shutters in the opening and closing direction is actuated by the at least one drive. In order to effect at least one additional function of the folding shutter arrangement, such as folding up, pulling up, unlocking or locking, at least at the beginning of opening and at the end of closing, or in order to effect a vertical and/or horizontal relative movement of a gate element edge that does not fold up, at least one adjustment means is provided, which is likewise actuable by the same drive. Furthermore, at least one clutch means is provided, which is actuated or activated depending on the pivoting, i.e. in particular pivoted states or pivoting phases of the folding shutter elements. The clutch means then couples the drive to the adjustment means in terms of driving in order that the adjustment means is actuated; or the clutch means uncouples the drive from the adjustment means when the adjustment means is no longer intended to be actuated.

### TECHNOLOGICAL BACKGROUND

Generic folding shutter arrangements from the same applicant are known, inter alia, from WO 2008/125343, filed on 16 Apr. 2008, from WO 2012/095324, filed on 16 Jan. 2012, and from the German utility model 20 2011 001 556.4, filed on 15 Jan. 2011, these being incorporated into the present disclosure by reference.

According to WO 2008/125343, a motorized drive is coupled indirectly to the adjustment means in that the coupling means acts between the adjustment means and the lifting and lowering means. In particular, the lifting and lowering means is a traction means that is able to be wound up or an endlessly circulating traction means. Uncoupling takes places in a correspondingly converse manner. Similarly, the coupling and uncoupling takes place by means of a coupling means which acts between the lifting/lowering means and the adjustment means when a remote control element controls the adjustment means remotely from the upper end region or from the lower end region of the guide rail and the adjustment means acts for example in a central region of the folding shutters (folding elements or pairs of folding elements).

According to WO 2012/095324, the clutch means has the effect that, at the beginning of the opening movement and at the end of the closing movement, an element edge a gate element edge which does not fold up is moved vertically and/or horizontally in a relative manner with respect to a lower carriage of the folding shutter arrangement, which is guided in or on the guide rails, in order to improve for example the opening and closing mechanics.

The previously known folding shutter arrangements make it possible, with a single drive, to reliably execute not only lifting and lowering but also at least one further function of the folding shutter arrangement. Such drive arrangements require care when setting the clutch means during fitting and/or different subassemblies are necessary, which are spaced apart from one another to a greater or lesser extent depending on the size of the folding gate. The lifting and lowering means, such as a traction cable or a traction strap, in particular having a toothed belt section, is directly involved in the coupling and uncoupling operation.

### SUMMARY OF THE INVENTION

Against this background, the invention is based on the object of creating a compact drive assembly. In order to achieve this object, a folding shutter arrangement having the features of one of claims 1 to 3 is proposed. According thereto, in a generic folding shutter arrangement, provision is made according to a first aspect of the invention for the clutch means to be assigned, in particular directly, to a driveshaft of the drive or to the drive itself. The invention creates a compact drive unit which consists of the, preferably motorized, drive and the clutch means. The drive is assigned the lifting and lowering means on the one hand and—via the clutch means—the adjustment means on the other hand. Rather than a motorized drive—which is preferred per se—a manual drive, for example having a hand crank transmission, also comes into question. In any case, a very compact drive arrangement is created. Complex adjustment work or the keeping of user-specific component variants in stock are dispensed with.

According to a second aspect of the invention, provision is made in a generic folding shutter arrangement for the drive or the driveshaft to be assigned on the one hand to the lifting and lowering means and on the other hand, separately from the lifting and lowering means, to the adjustment means. As a result, it is possible to embody the lifting and lowering means, in a manner divorced from the requirements which are to be placed on the adjustment means, in accordance with the lifting and lowering task for the sometimes very heavy folding shutter element. By contrast, the adjustment means, in addition to the clutch means, is independent of the design of the lifting and lowering means and can be embodied with regard to this task and in accordance with the comparatively low adjustment forces compared with the lifting and lowering means. It is also possible, by way of suitable step-down or step-up transmissions, for the clutch means and/or the lifting and lowering means to be driven at different rates by the drive.

According to a third aspect of the invention, the clutch means is designed such that it comprises a first clutch part that is arranged on the driveshaft or the drive for conjoint rotation and a second clutch part that is arranged so as to rotate freely on or with respect to the driveshaft or the drive and is able to be coupled to and uncoupled from the first clutch part. The second clutch part can be provided with a connecting rod means that is drive-connected to the adjustment means. In this way, the second clutch part arranged on the driveshaft converts, in the engaged state, the rotary movement generated by the drive into a linear movement by way of which the adjustment means is actuated directly or with the aid of an extension means known per se in a position remote from the drive.

In all three aspects of the invention, it is possible to use very different lifting and lowering means for the actual opening and/or closing, i.e. including a drive spindle, preferably for each guide rail.

In order, in the disengaged state of the clutch means, to hold the adjustment means securely in the position it has then taken up, the connecting rod means or the adjustment means can be provided with a position holding means, for example having a latching means, which interacts with the connecting rod means or the adjustment means so as to be latchable and unlatchable in a spring elastic manner.

It is now possible in various ways to embody the invention according to the above aspects:

According to a first embodiment of the invention, the folding shutter arrangement is equipped with a first, a second and a third transmission means, wherein the third transmission means is able to be coupled and uncoupled with respect to the driveshaft or the drive, which receive(s) the first transmission means for conjoint rotation, on the one hand, and with respect to the second transmission means, on the other hand, and is thus drivable by the drive or the driveshaft in the engaged state. This allows a simple structure of the clutch means, in which the second transmission means moves the adjustment means during the engaged working phase.

At least one of the transmission means can be assigned directly to the driveshaft, in particular be arranged concentrically on the driveshaft. As a result, in addition to possibly further ones of the above mentioned advantages, clutch elements of simple design, for example in the form of standard components, are usable. In particular, the first, second and third transmission means can be ones that have mutually meshing gearwheels. Likewise, frictional transmission means are also usable. Particularly preferably, the third transmission means can be brought into and taken out of engagement with the first and second transmission means by a simple pivoting operation. The pivoting operation of the third transmission means can be triggered by pivoting of the folding shutter element or of one of the folding shutter elements in that the third transmission means is kept out of engagement in the open state of the folding shutter. As soon as the closing folding gate is supported against a for example pivotable stop of the clutch means and pivots it for example together with the third transmission means, the third transmission means is brought into engagement with the first and second transmission means and thus with the driveshaft. The pivotable stop can be provided for example on a lever or comprise the latter.

The engagement and disengagement can also be triggered or brought about in the further clutch means, to be explained below, by pivoting the folding shutter element or one of the folding shutter elements.

The engagement and disengagement can take place both automatically and manually.

The engagement and disengagement and/or the lifting and lowering can take place, if desired, by means of pneumatic or hydraulic piston/cylinder arrangements.

In the (first) embodiment of the clutch means as a three-member transmission, two (first and second) transmission means are thus arranged, preferably coaxially, on the driveshaft and can, if desired, have the same outer circumference. The first transmission means runs together with the driveshaft while the second transmission means runs freely in the disengaged state.

In order to be able to maintain the engaged state for a further short time when the folding shutters are already moving out of their extended closed position, a pivot lever for pivoting the third transmission means can be provided with a storage means in order to bridge a certain idle travel at the start of folding shutter opening and at the end of folding shutter closing. Therefore, the clutch means is only disengaged when the folding shutter arrangement has passed through a certain pivoting movement or the drive for opening has passed through a certain travel. In a correspondingly converse manner, an idle travel is likewise passed through shortly before the end of the closing operation. An idle travel bridging arrangement is already known as such for the opening and closing operation of the folding shutter arrangement. This is with the aim of temporally separating the actuation of the adjustment means from the actual operation of opening and/or closing the folding shutter arrangement, at least in certain phases. According to the invention, a (separate) idle travel bridging means is now also provided alternatively or in addition for the clutch (clutch means) actuating the adjustment means.

An alternative, particularly preferred, clutch means comprises a first clutch part that is arranged on the driveshaft or the drive for conjoint rotation and a second clutch part that is arranged so as to rotate freely on or with respect to the driveshaft or the drive and is able to be coupled to and uncoupled from the first clutch part. Clutch disks that are arranged on the driveshaft and correspond to one another can be used as clutch parts, preferably one of said clutch disks being axially displaceable. The one clutch part is preferably rotationally conjoint with respect to the drive and the other clutch part is preferably rotationally free. The corresponding clutch disks can be embodied in a wide variety of ways; they can comprise for example corresponding spur toothings, pins with corresponding receiving holes, or friction linings An axial displacement of one of the two clutch disks, preferably of the first clutch disk, can be brought about in various ways. A pivot linkage arrangement can be provided, which displaces the first clutch disk, for example by way of the folding shutter movement, purely mechanically into the closed position (of the clutch). Such pivot linkage arrangements for actuating clutch disks, i.e. including rotating clutch disks, are known per se. The opening of the clutch can be supported or brought about for example by at least one compression spring, when this spring or these springs act(s) between the two corresponding clutch disks.

The opening and closing of the above mentioned clutch can also take place by means of a linear drive means which displaces one of the two clutch parts along the driveshaft between its closed and open position in that the rotary movement of the driveshaft is converted into a linear movement. This is possible for example with a spindle drive. In particular, the driveshaft can be embodied as or be provided with a drive spindle on a corresponding shaft section. A spindle nut rotatably arranged on the drive spindle can then move axially as linear guide means. To this end it is rotatably supported, possibly in a spring elastic manner, on an end side of one of the two clutch parts and consequently moves toward or away from the corresponding clutch part. It is only in an end region of the drive spindle that the clutch is engaged or disengaged. The release point of the clutch can be adjusted for example by twisting the spindle nut into a different zero position. It is only after the clutch has been released or together therewith that the rotary inhibition and linear guide are activated in order to make the spindle nut twist resistant. The linear guide can be provided with additional rough and/or fine adjustment means, such as a plurality of guide options on the spindle nut circumference and/or slots for the fine adjustment of the circumferential position of the linear guide means of the spindle nut.

It is furthermore possible, when a linear drive means is used, to use a spindle drive, in particular in combination with an electromagnetic spindle drive. In this way, it is particularly easy for the clutch to be active or to engage in a precisely defined rotational position of the driveshaft. The electromagnetic drive part can be embodied, inter alia, as is explained with regard to the alternative described below.

It is also possible for just a permanent magnet or electromagnet to serve as a further alternative to the axial displacement of one of the two clutch parts, the axially movable armature of said magnet being able to be connected or connectable to one of the clutch means directly or indirectly, rigidly or in a spring elastic manner, in a rotationally free or rotationally conjoint manner. The solenoid then preferably concentrically encloses the driveshaft. The activation of the solenoid without or with current for the purpose of engagement and disengagement then takes place in dependence on the folding shutter position. This can take place mechanically via a spindle drive, or electrically by an incremental counter or via the electronic control of the drive of the folding shutter arrangement. In the case of the three-member transmission means mentioned further above, too, the pivotable one of these transmission means can be activated magnetically, in particular electromagnetically.

The transmission of movement between the rotating clutch and the adjustment means can, as already mentioned further above, take place in very different ways, in particular with the aid of a connecting rod means as per the third aspect of the invention. It is also possible to allow the adjustment means to act directly on one of the folding shutter elements, in that it blocks the folding shutter in the closed extended position thereof by way of a linkage driven by the clutch (it then acts in a locking manner) or folds it out of the extended position.

The above mentioned components to be used according to the invention and also those that are claimed and described in the exemplary embodiments are not subject to any particular exceptions in terms of their size, shaping, material selection and technical design, and so the selection criteria known in the field of application can be applied without restriction.

Further details, features and advantages of the subject matter of the invention can be gathered from the dependent claims and from the following description and the associated drawings, in which—by way of example—exemplary embodiments of a folding shutter arrangement are illustrated. In addition, individual features of the claims or of the embodiments can be combined with other features of other claims and embodiments.

### BRIEF DESCRIPTION OF THE FIGURES

In the drawings:

FIG. 1A shows a folding shutter arrangement consisting of two folding shutter elements (in the form of a detail) in an end-side view with the folding gate closed and locked;

FIG. 1B shows the same folding shutter arrangement (in the form of a detail) in an approximately completely open state;

FIG. 2 shows an alternative embodiment of the drive assembly of a folding shutter arrangement (in the form of a detail) according to FIG. 1A/B;

FIG. 3A-C show an alternative embodiment of the drive assembly of a folding shutter arrangement (in the form of a detail) according to FIG. 1A-2;

FIG. 4A-C show a further alternative embodiment of the drive assembly of a folding shutter arrangement (in the form of a detail);

FIG. 5A-C show a further alternative embodiment of the drive assembly of a folding shutter arrangement (in the form of a detail);

FIG. 6A-L show a motion sequence for a further alternative embodiment of a folding shutter arrangement (in the form of a detail); and

FIG. 7A-E show a further alternative embodiment of the drive assembly of a folding shutter arrangement (in the form of a detail).

### DETAILED DESCRIPTION OF EXEMPLARY EMBODIMENTS

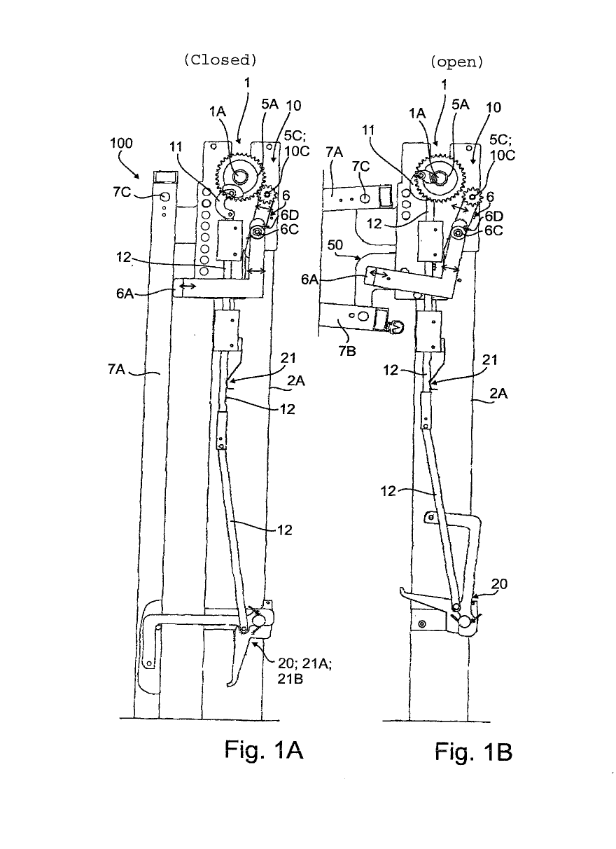

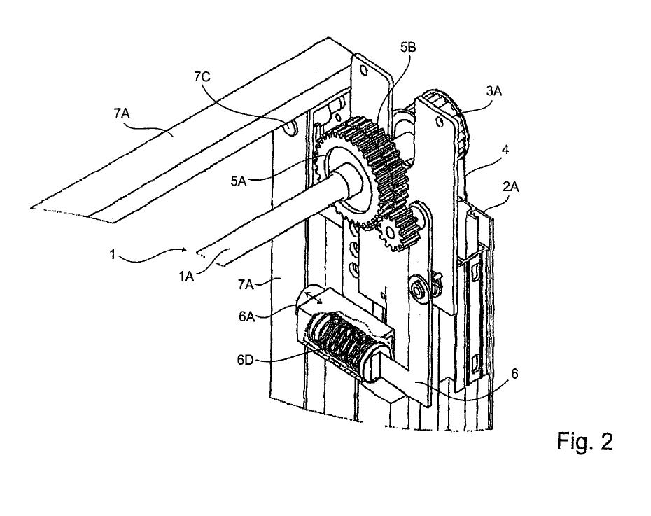

According to the first exemplary embodiment according to FIGS. 1 to 2, a driven, preferably motor-driven, driveshaft 1A, which is arranged in a fixed position in the upper end region or above the upper end of guide rails 2A, 2B on both sides, bears at least one drive wheel 3A, 3B, connected thereto for conjoint rotation, for lifting and lowering (see FIG. 2). The drive wheel is, as illustrated by way of example, a drive pinion for at least one lifting and lowering means 4 known per se configured as a toothed belt and indicated in FIG. 2, said lifting and lowering means 4 preferably circulating endlessly and being arranged in a manner known per se along the at least one guide rail 2A. Alternatively, a spindle drive or a piston/cylinder drive is also possible.

The lifting and lowering means 4 is connected for lifting and lowering purposes to a guide carriage 50, illustrated in FIG. 1B, in the lower region of the lower folding shutter 7B, as is known per se, for example from WO 2008/125343, WO 2012/095324 or the German utility model 20 2011 001 556.4, such that the lifting or guide carriage can lift and lower the lower folding shutter element edge close to the guide rail in a manner known per se.

Connected to the driveshaft 1A for conjoint rotation is a drive sprocket, which consequently rotates together with the drive wheel 3A and the driveshaft 1A in a constantly synchronously driven manner and serves as a first transmission means 5A. A third transmission means 5C is pivoted with regard to the guide rail 2A about a fixed pivot pin 6C of a two-arm pivot lever 6 into the engaged position (illustrated in FIG. 1A). A stop means 6A that is adjustable, possibly also multiaxially, with respect to the pivot lever 6 holds the third transmission means 5C in engagement with the drive sprocket (transmission means 5A) fitted on the driveshaft (1A) for conjoint rotation, specifically for as long as the folding shutter arrangement, in particular the upper folding shutter element 7A, bears, in its extended closed position or approximately closed position, against the stop means 6A and holds the third transmission means 5C in its engaged position (FIG. 1A). Therefore, the third transmission means 5C represents a third clutch part 10C of a clutch means 10, which consists of the first to third transmission means 5A-C in the illustrated exemplary embodiment which is preferred in this respect. The drive sprocket and the second transmission means 5B, which is mounted on the driveshaft 1 so as to rotate freely and is explained further below, together represent the parts that are to be coupled together, while the third transmission means 5C serves as the means that optionally establishes the form fit of the clutch and is moved to and from (to the side—or radially) for this purpose.

Fitted on the driveshaft 1A, axially alongside the drive sprocket (first transmission means 5A), is the second transmission means 5B, which is mounted rotatably with respect to the driveshaft (1A). In the illustrated exemplary embodiment which is preferred in this respect, said second transmission means 5B is a sprocket, which can be identical to the drive sprocket in terms of outside diameter and toothing.

The second transmission means 5B bears, on one of its end sides, a linear drive coupler, also referred to as connecting rod means 11 below, which converts the rotary movement of the transmission means 5B into a linear movement. Its contour (in the side view illustrated) is preferably crescent-shaped. Via an extension means 12 (which has two members in the exemplary embodiment), an adjustment means 20 known per se is actuated, and as a result of its movement, in particular pivoting movement,—as is known per se—one folding shutter element, in the exemplary embodiment the upper folding shutter element, can be locked and unlocked, and can be folded up out of its extended position and pulled up back into its position.

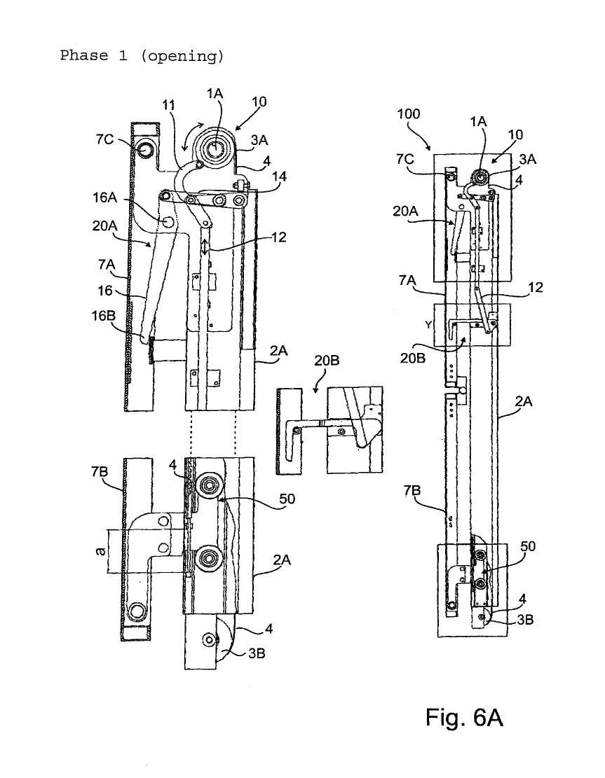

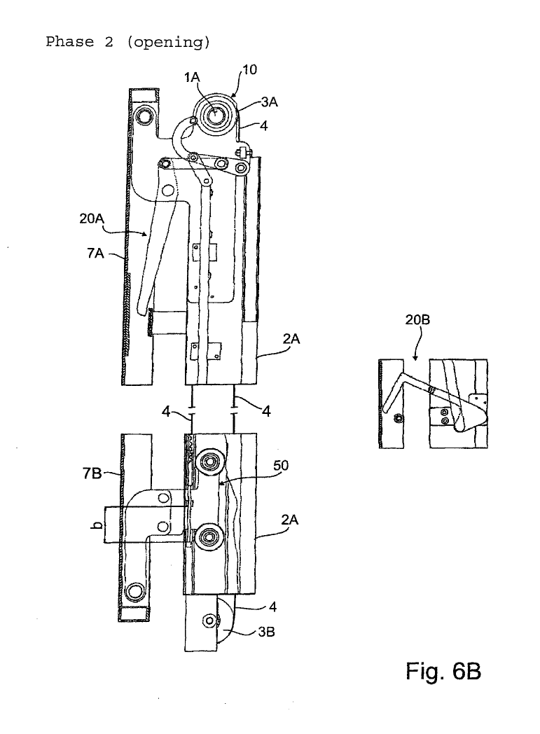

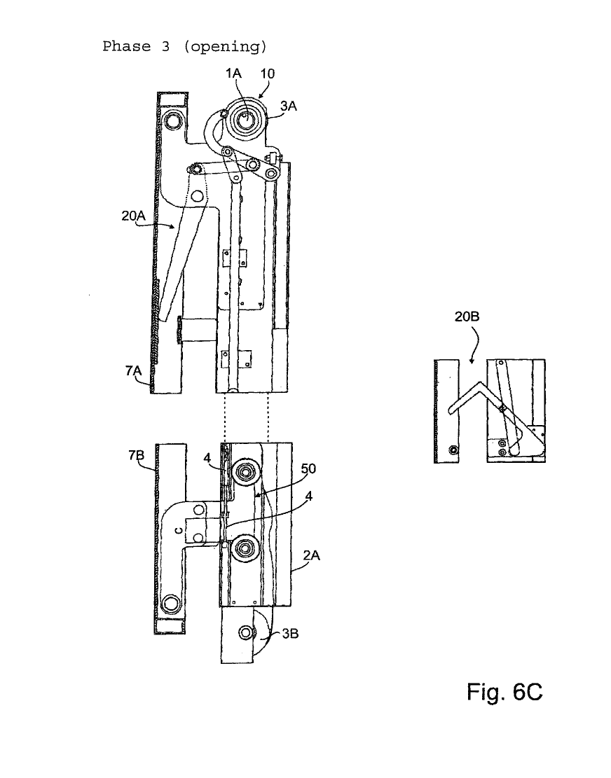

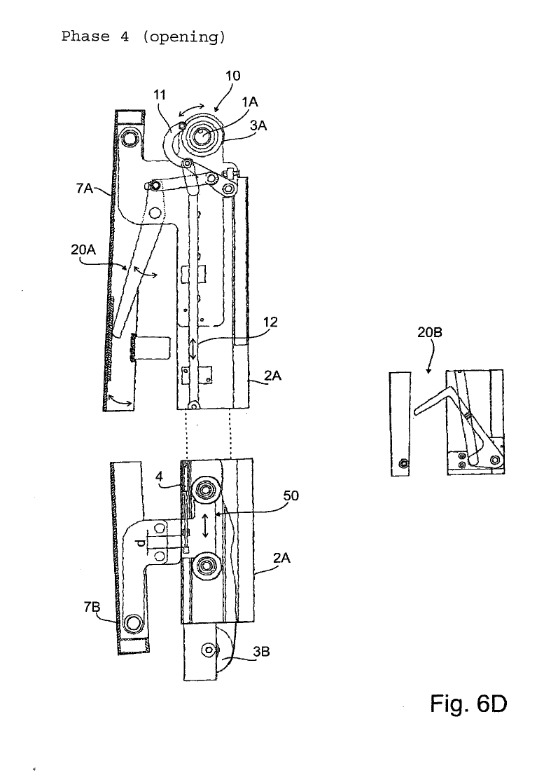

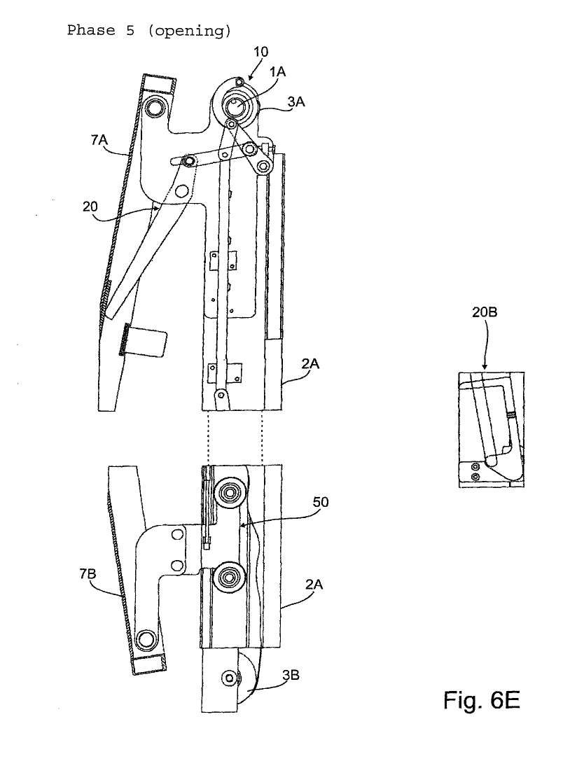

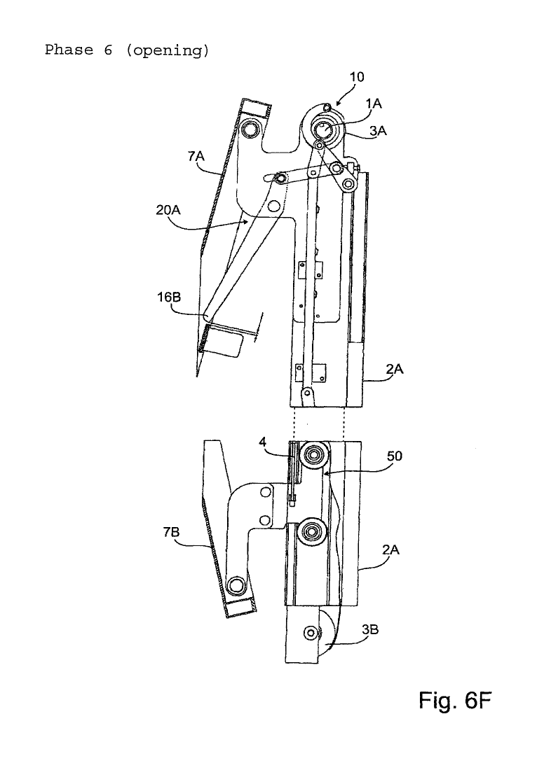

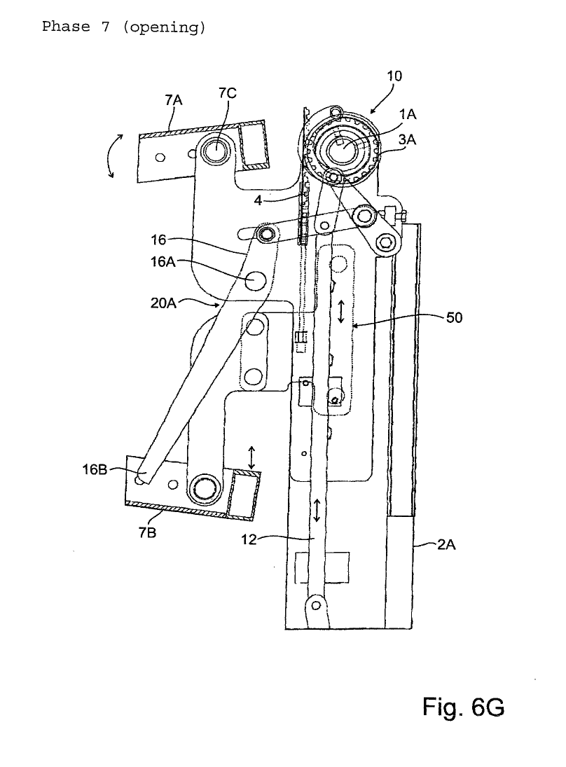

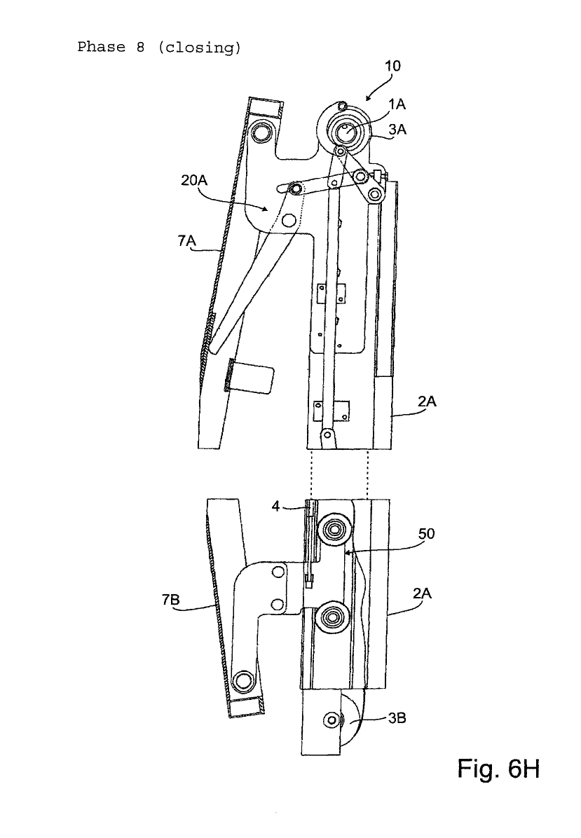

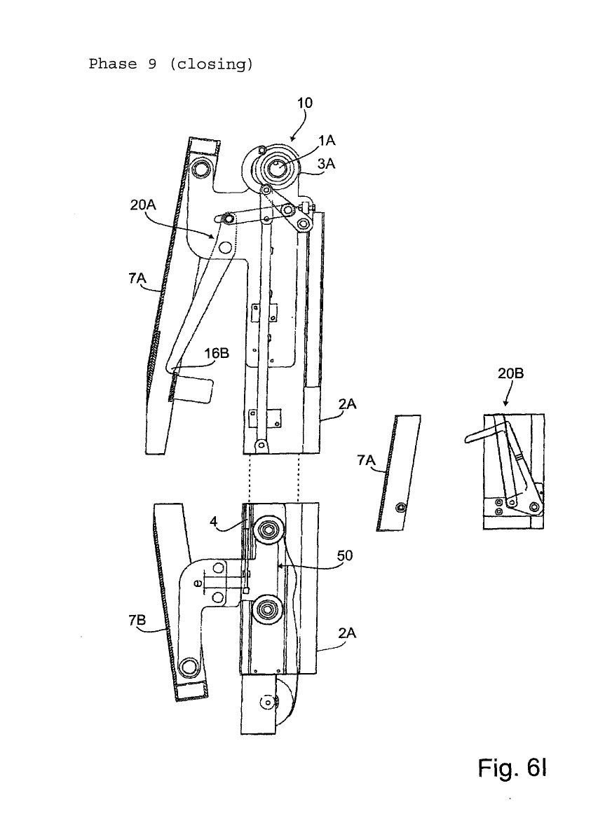

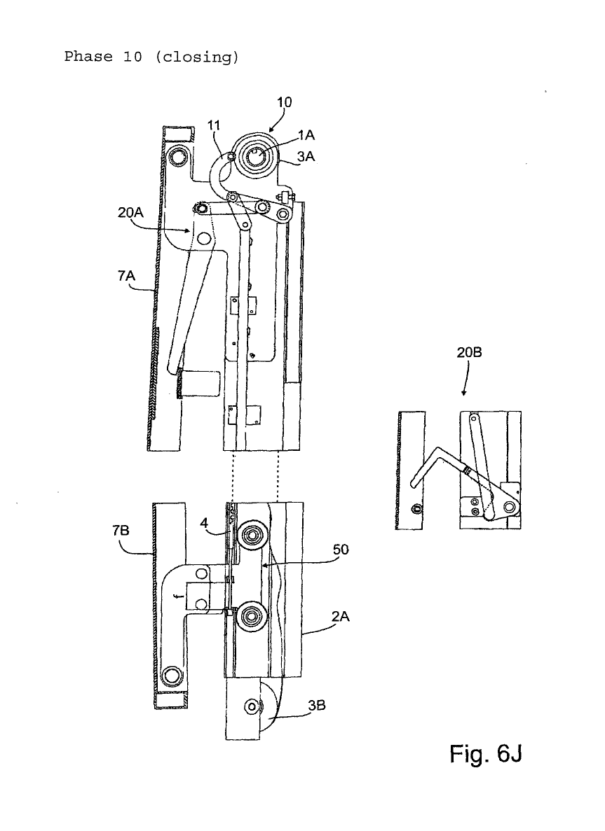

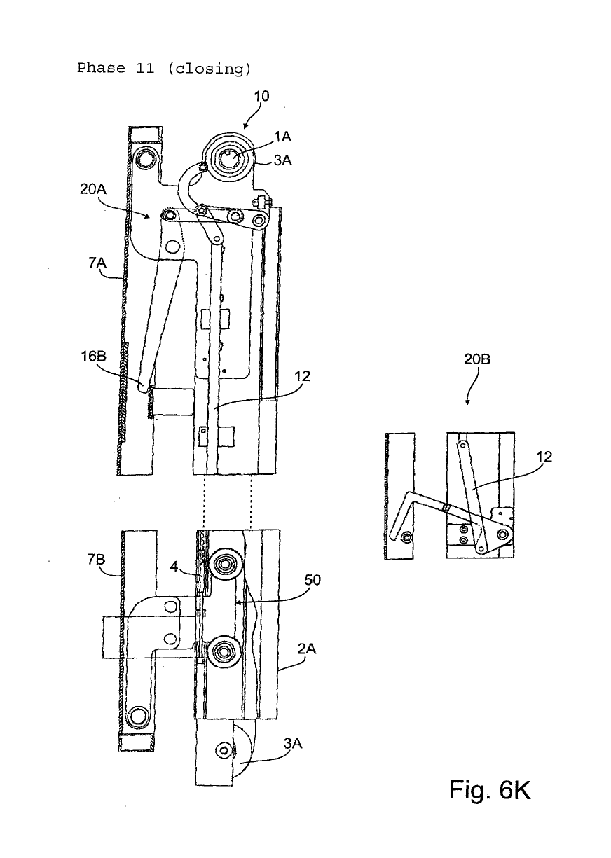

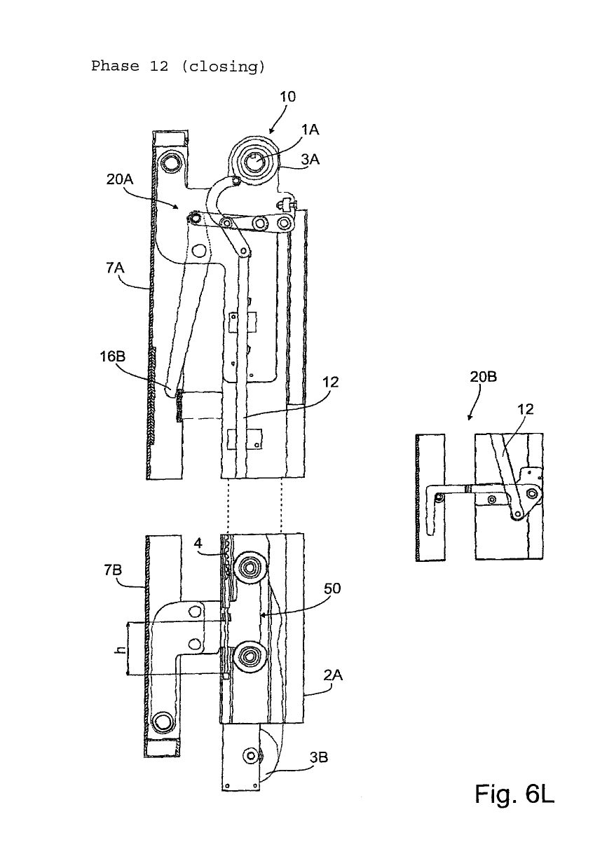

The exemplary embodiment according to FIGS. 1 to 2 functions in that, starting from the completely closed position according to FIG. 1A, a driven, for example motor-driven, rotation of the driveshaft 1A in a first opening phase (unlocking phase) drives the drive sprocket, the third transmission means 5C that meshes therewith and the second transmission means 5B that in turn meshes therewith in rotation. As a result, the linear drive coupler (connecting rod means 11) is lifted from its first position, located for example at bottom dead center, into a lifted second position, in particular into the vicinity of top dead center. In this case, the extension means 12 is lifted and the adjustment means 20 is displaced from its locking position illustrated in FIG. 1A to its unlocking position illustrated in FIG. 1B. In the process, the lifting and lowering means 4 is moved along therewith at the same time, wherein it is possible for the lower gate edge to be lifted with a time delay, however, because for example an idle travel bridging arrangement 60 known per se can be provided on the lifting and lowering means or the guide carriage 50 that is connected thereto, is not illustrated in the drawing but is known per se. A detailed motion sequence can be gathered from FIGS. 6A-L.

As soon as the lifting and lowering means 4 lifts the lower edge of the folding shutter arrangement and as a result the upper folding shutter element is pivoted partially outward, the pivot lever 6 also pivots. Its stop means 6A in the process follows first of all the upper folding shutter element under the action of a spring that serves as storage means 6D. It is only at the end of the, possibly limitable, spring travel that the third transmission means 5C passes out of engagement with the drive sprocket on the one hand and with the second transmission means 5B on the other. In this situation, the top dead center of the linear drive coupler can be reached under certain circumstances. Upon continued lifting of the lower gate edge, the pivot lever 6 stops in its uncoupling position illustrated in FIG. 1B and it holds the third transmission means 5C out of engagement. Position holding means 21, such as a leaf spring, illustrated in FIGS. 1A/B, that is latchable in and unlatchable from different notches in the extension means 12, can hold the second transmission means 5B and the adjustment means 20 releasably in the particular engaged or disengaged position.

In the variant according to FIG. 2, the storage means 6D is assigned to the stop means 6A, such that the latter is variable in position. A leg spring can hold the third transmission means 5C in its disengaged position as long as the stop means 6A does not bear against the upper folding shutter 7A, i.e. is not in a closed position.

However, pivoting out of the folding shutters can also be brought about by forces emanating from the center of gravity or wind suction, specifically when the lifting and lowering means enables travel at the lower carriage and the lock at the locking point has been unlocked.

It is only when the folding shutter arrangement is as good as completely closed again, but is still slightly folded, that the upper folding shutter element (in this exemplary embodiment) is located back in contact with the stop means 6A, this resulting, upon further pivoting into the extended position, illustrated in FIG. 1A, of the folding gate, in the re-engagement of the first transmission means 5A (drive sprocket) and the second transmission means 5B. During the rest of the motion sequence, with the driveshaft 1A rotating further, the linear drive coupler (connecting rod means 11) is pivoted back into its lower position, illustrated in FIG. 1A, or into the vicinity of the bottom dead center position. This has the result that the folding shutter arrangement is locked.

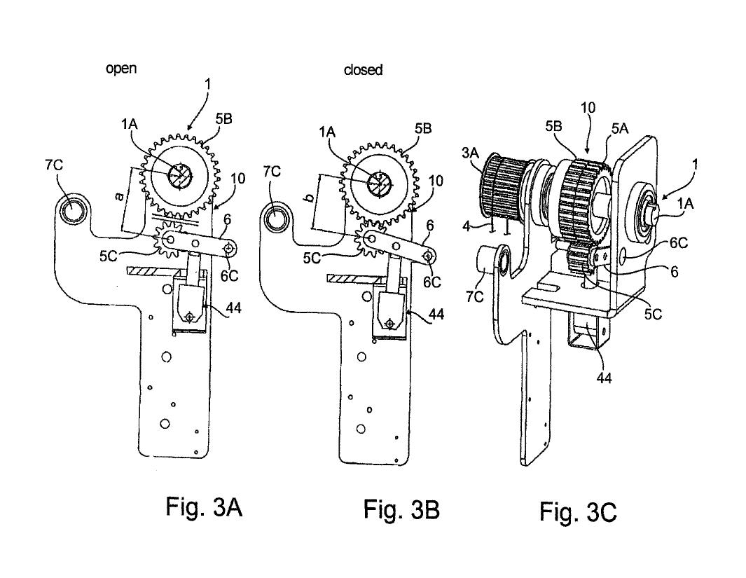

Another possibility of engaging and disengaging the transmission means 5A-C (i.e. the clutch means 10) is illustrated in FIGS. 3A-C. Here, the mechanical interaction between the upper folding shutter 7A and a stop means can be omitted if desired. An electromagnet 44 or—alternatively—some other electric, pneumatic, hydraulic or manual drive (including by means of a lever or chain) pivots the third transmission means 5C between its engaged state (FIG. 3B) and its disengaged state (FIG. 3A).

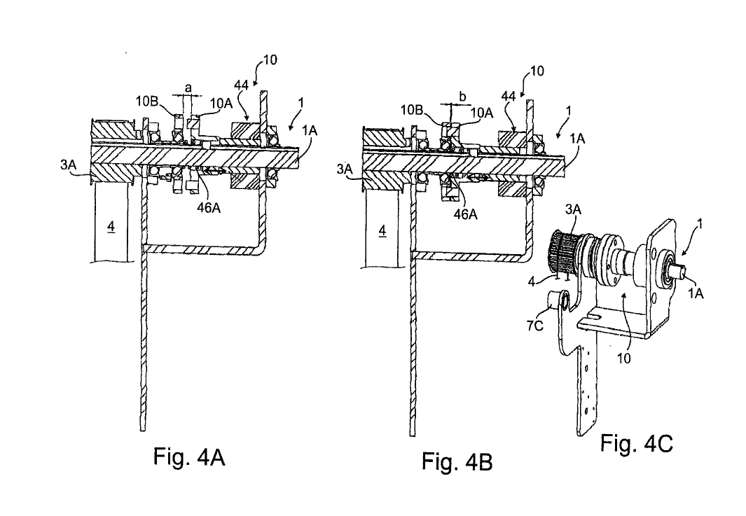

Instead of a gearwheel transmission or friction wheel transmission (transmission means 5A-C), the clutch means 10 can be embodied as an axial clutch (FIGS. 4, 5 and 7). In this case, the third transmission means 5C is omitted. Instead, at least one of the two clutch disks (first, rotationally conjoint and/or second, rotationally free clutch part 10A and/or 10B) is mounted in an axially movable manner, for example on the driveshaft 1A.

In the exemplary embodiment according to FIGS. 4A-C, the first clutch part 10A is mounted on the driveshaft 1 for conjoint rotation and in an axially displaceable manner and is able to be brought into and taken out of engagement with the clutch part 10B that is free to rotate via engagement of axially protruding clutch elements, for example in the form of pins. The adjustment drive can be an electric drive 44.

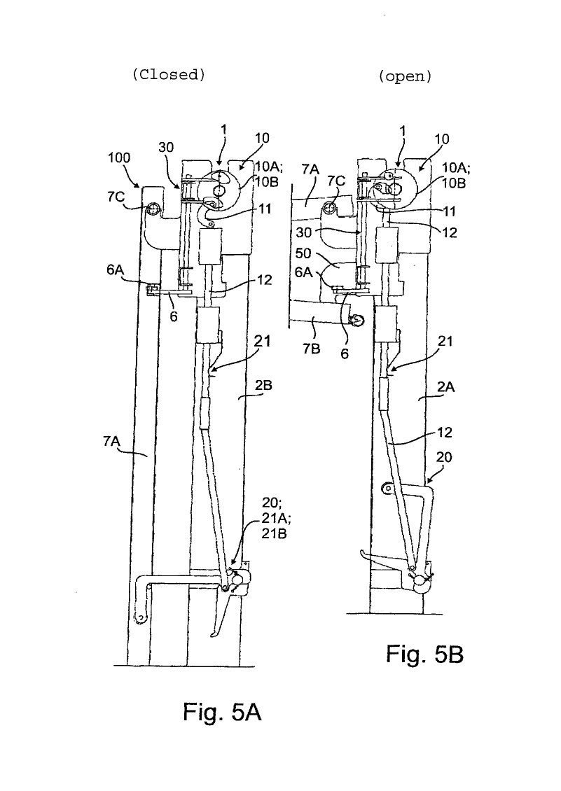

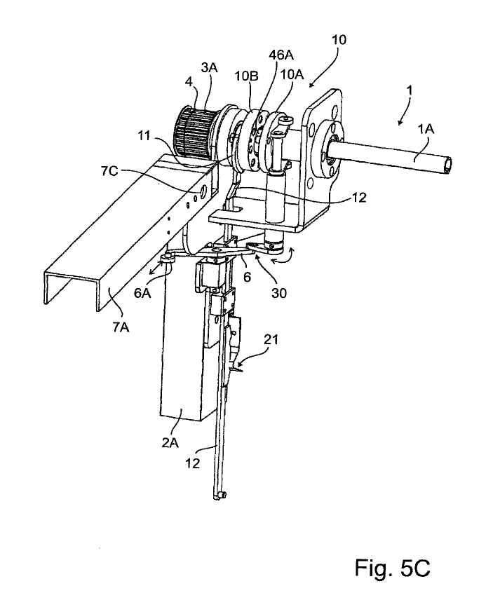

In the exemplary embodiment according to FIGS. 5A-C, too, the first clutch part 10A is mounted on the driveshaft 1A for conjoint rotation and in an axially displaceable manner and is able to be brought into and taken out of engagement with the clutch part 10B that is free to rotate via engagement of axially protruding clutch elements, for example in the form of pins. In this exemplary embodiment, the adjustment drive is of purely mechanical nature again, however. As already seen in the exemplary embodiment according to FIGS. 1A to 2, the upper folding shutter 7A being displaced acts on a pivot linkage arrangement 30 such that it brings the axially displaceable clutch part 10A that is rotationally conjoint with respect to the driveshaft 1A into or takes it out of engagement with the second, rotationally free clutch part 10B when the upper folding shutter 7A is close to its extended closed position. As also described and illustrated in the exemplary embodiment according to FIGS. 1A-2, the actuation of the adjustment means 20 takes place preferably via a connecting rod means 11. The same is preferred—even if not illustrated separately there—for the exemplary embodiment according to FIGS. 3 and 4.

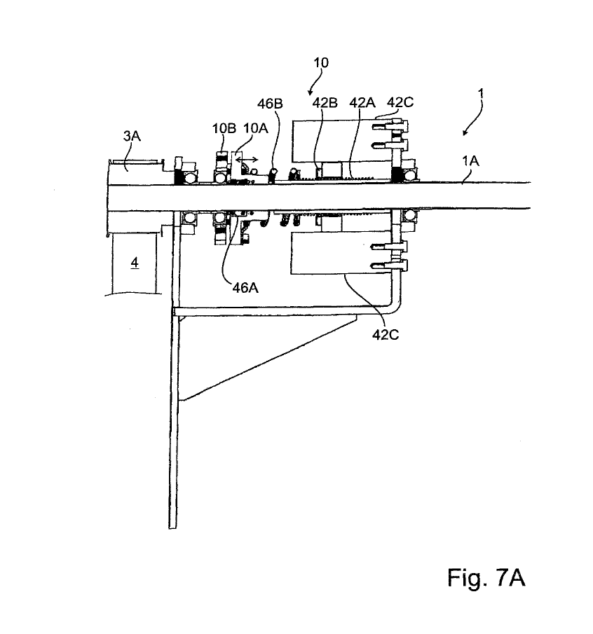

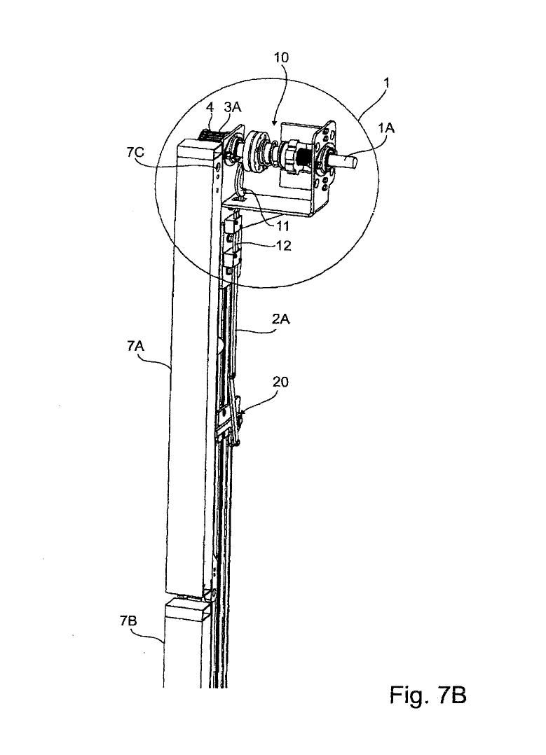

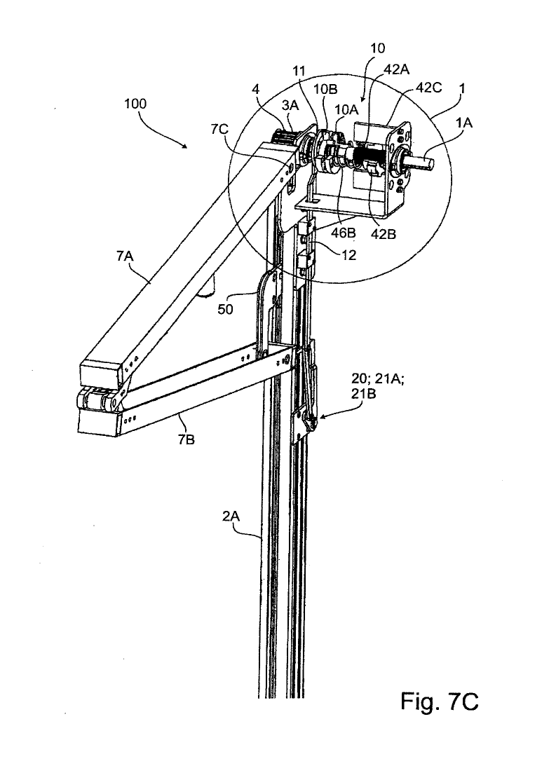

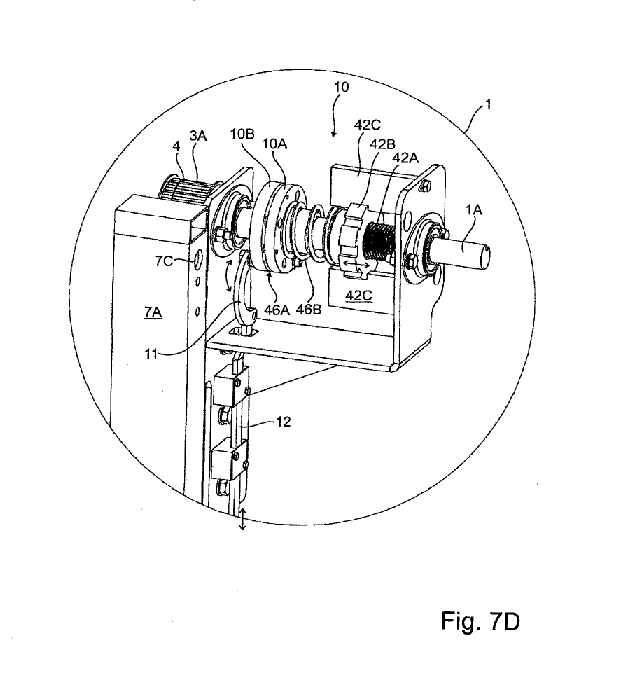

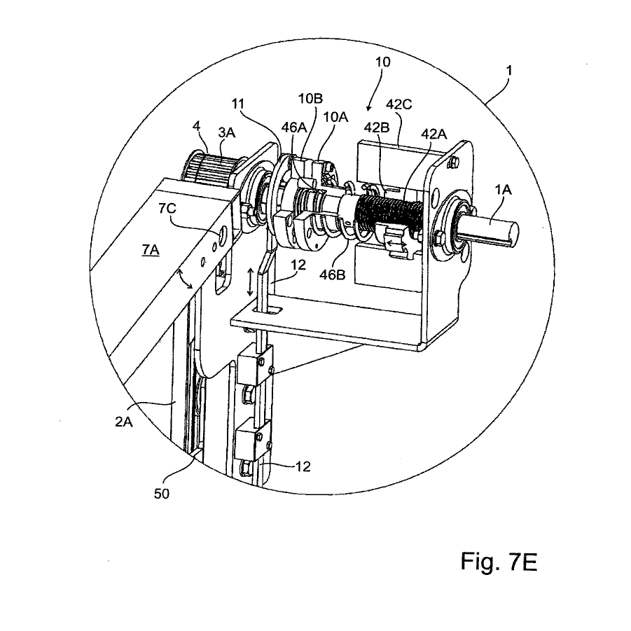

Yet another axial clutch can be gathered from the exemplary embodiment according to FIGS. 7A-E. As already seen according to the exemplary embodiment in FIGS. 4A-C, direct mechanical clutch actuation by the upper folding shutter 7A is not provided. Instead, engagement and disengagement takes place by means of a linear drive means in the form of a spindle drive 42. The latter comprises substantially a drive spindle 42A, a spindle nut 42B running thereon and a linear guide means 42C. The drive spindle 42A can be fitted as a sleeve on the driveshaft 1A for conjoint rotation. A first compression spring 46A holds the clutch means 10 open—as already seen in the exemplary embodiments according to FIGS. 4A to 5C, when the upper folding shutter 7A is not in the vicinity or the immediate vicinity of its closed position (extended position). A second compression spring 46B, which is stronger than the first compression spring 46A, acts between the first clutch part 10A and the spindle nut 42B—in any case close to the shift point of the clutch means 10. The spindle nut 42B moves, preferably throughout the opening and closing travel of the folding shutters, along the linear guide means 42C, which prevents twisting of the spindle nut 42B.

As already mentioned, the adjustment means 20 can take on very different functions, for instance, inter alia, the locking and unlocking of the folding shutter arrangement in its closed position, the folding up of the folding shutter arrangement from its closed position, and the pulling up of the folding shutter arrangement into its closed position. A multifunctional variant of the adjustment means 20 is apparent from the entire motion sequence according to FIGS. 6A-L. The motion sequence is also applicable to all other embodiments shown. The different clutch means 10 are thus usable for the exemplary embodiment according to FIGS. 6A-L.

One particular feature of the exemplary embodiment according to FIGS. 6A-L is a folding-up and pulling-up means 20A that acts directly on the upper folding shutter 7A in the upper region of the latter. In the illustrated exemplary embodiment which is preferred in this respect, the folding-up and pulling-up means 20A comprises at least control arm 14 and a lever 16 that is pivotable about a center of rotation 16A. With the one lever end 16B, the folding-up and pulling-up means 20A acts on the upper region of the upper folding shutter 7A—depending on the direction of movement of the lever end 16B—for the purpose of folding up or pulling up on the upper region of the upper folding shutter 7A. In the completely closed position, shown in FIG. 6A, of the folding shutter arrangement, overextension of the control arm 14 is illustrated. As a result, locking in the upper region of the upper folding shutter 7A is possible. The locking and unlocking means 20B, as is also apparent from the exemplary embodiments according to FIGS. 1, 5 and 7, can also be omitted if desired in the exemplary embodiment according to FIGS. 6A-L. The locking and unlocking means 20B can also be used as additional security against break-in and/or against wind suction.

### LIST OF REFERENCE NUMBERS

1 Drive means

1A Driveshaft

2A/B Guide rails

3A/B Drive wheels

4 Lifting and lowering means

5A First transmission means

5B Second transmission means

5C Third transmission means

6 Pivot lever

6A Stop means

6B Stop means

6C Pivot pin

6D Storage means

7A Folding shutter element

7B Folding shutter element

7C Upper pivot pin

10 Clutch means

10A First clutch part

10B Second clutch part

10C Third clutch part

11 Connecting rod means

12 Extension means

14 Control arm

16 Lever

16A Center of rotation

16B Lever end

20 Adjustment means

20A Folding-up and pulling-up means

20B Locking and unlocking means

21 Position holding means

30 Pivot linkage arrangement

40 Linear drive means

42 Spindle drive

42A Drive spindle

42B Spindle nut

42C Linear guide means

44 Electromagnet

46A First compression spring

46B Second compression spring

50 Guide carriage or carriage

60 Idle travel bridging arrangement

62 Idle travel bridging means

100 Folding shutter arrangement

1. An open- and closeable folding shutter arrangement,
having two or more pivotable folding shutter elements that are displaceable on at least one guide,
having at least one motorized or manual drive means, in particular a rotary drive, for opening or closing the folding shutter arrangement,
having at least one lifting and lowering means, actuated by the drive means, for displacing the folding shutter elements,
having at least one adjustment means actuated by the drive means, and
having at least one clutch means which is actuated or actuable depending on the pivoted state of the folding shutter elements, said clutch means coupling the drive means to the adjustment means in terms of driving or uncoupling it therefrom when the clutch means is actuated in one or the other direction depending on the pivoted state of one of the folding shutter elements,
characterized in that
the clutch means is assigned to a driveshaft of the drive means or to the drive means itself.

2. The folding shutter arrangement according to claim 1, characterized in that the drive or the driveshaft is assigned on the one hand to the lifting and lowering means and separately to the clutch means.

3. The folding shutter arrangement according to claim 1, characterized in that the clutch means comprises a first clutch part that is arranged on the driveshaft or the drive for conjoint rotation and a second clutch means that is arranged so as to rotate freely on or with respect to the driveshaft or the drive and is able to be coupled to and uncoupled from the first clutch part, and the second clutch part is provided with a connecting rod means that is drive-connected to the adjustment means.

4. The folding shutter arrangement as claimed in claim 1, characterized in that the clutch means comprises a first clutch part that is arranged on the driveshaft or the drive for conjoint rotation and a second clutch part that is arranged so as to rotate freely on or with respect to the driveshaft or the drive and is able to be coupled to and uncoupled from the first clutch part, and the first clutch part is a clutch disk that is axially displaceable on the driveshaft.

5. The folding shutter arrangement as claimed in claim 4, characterized in that the first clutch part is able to be brought into and taken out of engagement with the first clutch part by a pivoting operation executed or brought about by one of the folding shutter elements.

6. The folding shutter arrangement as claimed in claim 4, characterized in that one of the clutch parts is displaceable into a closed position by the folding shutter movement by means of a pivot linkage arrangement.

7. The folding shutter arrangement as claimed in claim 4, characterized in that at least one of the clutch parts is displaceable into its closed and open positions by means of a linear drive means, such as a spindle drive, that is displaceable along the driveshaft by the rotary movement thereof.

8. The folding shutter arrangement as claimed in claim 4, characterized in that at least one of the clutch parts is displaceable into its closed and open positions by means of a permanent magnet or electromagnet that acts along the driveshaft.

9. The folding shutter arrangement as claimed in claim 1, characterized in that at least a first, a second and a third transmission part is provided, wherein the third transmission means is able to be coupled on the one hand to the driveshaft or the drive having the first transmission part and on the other hand to the second transmission part, and is thus drivable by the drive or the driveshaft in the engaged state.

10. The folding shutter arrangement as claimed in claim 9, characterized in that the first, second and third transmission means comprise gear wheels that mesh with one another.

11. The folding shutter arrangement as claimed in claim 9, characterized in that the third transmission means is able to be brought into and taken out of engagement with the first and second transmission parts by a pivoting operation executed or brought about by one of the folding shutter elements.

12. The folding shutter arrangement as claimed in claim 5, characterized in that the third transmission means is displaceable into its closed and open positions by means of a permanent magnet or electromagnet.

13. The folding shutter arrangement as claimed in claim 1, characterized by at least one pivot lever having a storage means for bridging an idle travel and/or for separating or opening the clutch.

14. The folding shutter arrangement as claimed in claim 1, characterized by a position holding means that holds a connecting rod means or the adjustment means in position in the disengaged state.

15. The folding shutter arrangement as claimed in claim 1, characterized by a folding-up and pulling-up means on the upper region of the upper folding shutter.
